(19) United States
(12) Patent Application Publication
(10) Pub. No.: US 2026/0056858 A1
(43) Pub. Date: Feb. 26, 2026

(54) HEALTH ASSESSMENT OF CONTAINER NETWORK INTERFACE (CNI) IN CONTAINERIZED CLUSTER

(71) Applicant: INTERNATIONAL BUSINESS MACHINES CORPORATION, ARMONK, NY (US)

(72) Inventors: SUNYANAN CHOOCHOTKAEW, Tokyo (JP); TATSUHIRO CHIBA, Tokyo (JP)

(21) Appl. No.: 18/811,935

(22) Filed: Aug. 22, 2024

(51) Int. Cl. G06F 11/30

(52) U.S. Cl. CPC G06F 11/301

(57) ABSTRACT

A method, computer program product, and computer system for assessing a health of a target container network interface (target CNI) disposed in a containerized cluster. The containerized cluster includes (i) multiple workers nodes that include a first worker node and a second worker node and (ii) a control plane configured to manage the worker nodes and pods disposed within the multiple worker nodes. The first worker node includes a checker pod. A target worker node, which is the first worker node or the second worker node, includes the target CNI and an agent pod. The agent pod receives, from the checker pod, a request to check a health of the target CNI. The health check includes configuring one or more secondary networks within the containerized cluster. The agent pod sends, to the checker pod, results of configuring the one or more secondary networks.

### BACKGROUND

The present invention relates to container network interfaces (CNIs), and more specifically, to a health assessment of CNIs in a containerized cluster.

### SUMMARY

Embodiments of the present invention provide a method, a computer program product, and a computer system, for assessing a health of a target container network interface (CNI) disposed in a containerized cluster. One or more processors of a computer system provide the containerized cluster. The containerized cluster comprises (i) multiple workers nodes that include a first worker node and a second worker node and (ii) a control plane configured to manage the worker nodes and pods disposed within the multiple worker nodes. The first worker node comprises a checker pod. The target CNI is in a target worker node comprising the first worker node or the second worker node. The target worker node comprises an agent pod. The agent pod receives, from the checker pod using the one or more processors, a request to check a health of the target CNI. In response to said receiving the request, the agent pod performs, using the one or more processors, the health check of the target CNI, where performing the health check of the target CNI comprises triggering, by the agent pod, the target CNI to configure one or more secondary networks within the containerized cluster. The agent pod sends, to the checker pod using the one or more processors, results of configuring the one or more secondary networks by the target CNI.

### BRIEF DESCRIPTION OF THE DRAWINGS

FIG. 1 depicts a system comprising a Kubernetes cluster and an Admin which is a person responsible for managing and maintaining the Kubernetes cluster, in accordance with embodiments of the present invention.

FIG. 2 depicts the system of FIG. 1 with a checker pod inserted into a worker node A in the Kubernetes cluster, in accordance with embodiments of the present invention.

FIG. 3 depicts the system of FIG. 2 with agent pods inserted into respective worker nodes A, B, and C, in accordance with embodiments of the present invention.

FIG. 4 depicts the system of FIG. 3 with health checking of target container network interfaces (target CNIs) utilizing dummy container network namespaces, in accordance with embodiments of the present invention.

FIG. 5 depicts reporting the results of the health check of target CNIs in respective worker nodes, in accordance with embodiments of the present invention.

FIG. 6 depicts a comparison of a conventional method and the inventive method of the present invention for checking the health of respective target CNIs, in accordance with embodiments of the present invention.

FIG. 7 is a flow chart of a method for assessing a health of a target container network interface (CNI) disposed in a containerized cluster, in accordance with embodiments of the present invention.

FIG. 8 is a flow chart of a process that performs the health check of the target CNI in a step of FIG. 7 in more detail, in accordance with embodiments of the present invention.

FIG. 9 is a flow chart of a process that creates a checker pod, in accordance with embodiments of the present invention.

FIG. 10 is a flow chart of a process that creates an agent pod, in accordance with embodiments of the present invention.

FIG. 11 illustrates a computer system, in accordance with embodiments of the present invention.

FIG. 12 depicts a computing environment which contains an example of an environment for the execution of at least some of the computer code involved in performing the inventive methods, in accordance with embodiments of the present invention.

### DETAILED DESCRIPTION

According to an aspect of the invention, a health of a target container network interface (CNI) disposed in a containerized cluster is assessed. One or more processors of a computer system provide the containerized cluster. The containerized cluster comprises (i) multiple workers nodes that include a first worker node and a second worker node and (ii) a control plane configured to manage the worker nodes and pods disposed within the multiple worker nodes. The first worker node comprises a checker pod. The target CNI is in a target worker node comprising the first worker node or the second worker node. The target worker node comprises an agent pod. The agent pod receives, from the checker pod using the one or more processors, a request to check a health of the target CNI. In response to receiving the request, the agent pod performs, using the one or more processors, the health check of the target CNI, where performing the health check of the target CNI comprises triggering, by the agent pod, the target CNI to configure one or more secondary networks within the containerized cluster. The agent pod sends, to the checker pod, results of configuring the one or more secondary networks by the target CNI. The checker pod sends the results to a monitoring pod within one worker node of the multiple worker nodes. The monitoring pod exports, to an admin outside of the containerized cluster, the results, where the admin has access to an Application Programming Interface (API) server within the control plane

The preceding aspect of the invention provides a technical feature of detecting secondary network failures in advance, which prevents occurrence of such failures during real time execution of applications.

In addition, the preceding aspect of the invention provides a technical feature of sending, to the checker pod, results of configuring the one or more secondary networks by the target CNI, which enables the checker pod to transmit the results, via a monitoring pod, to an admin, via a monitoring pod, so that the admin can take corrective action to repair any detection of secondary network connection failures, as well as any functionality failure, that may have been detected via the health check.

In first embodiments, performing the health check of the target CNI comprises: creating, by the agent pod, a dummy container network namespace in the target worker node; triggering, by the agent pod, an ADD command resulting in the target CNI configuring the one or more secondary networks within the containerized cluster; triggering, by the agent pod, a DEL command that reverses the configuring of the one or more secondary networks; and deleting, by the agent pod, the dummy container network namespace. In addition, the agent pod calls, via the dummy container network namespace, endpoints at interfaces within the checker pod, where the calling of the endpoints triggers a check of connections between the dummy container network namespace and the checker pod.

The preceding first embodiments provide technical features based on the agent pod triggering the target CNI to configure the one or more secondary networks, and subsequently to reverses the configuring of the one or more secondary networks, without using the user's resources and without disturbing the user's utilization the containerized cluster. In addition, the agent pod performs only minimum actions that: create, and subsequently delete, a dummy container network namespace; trigger execution of CNI commands that to configure, and subsequently delete configuration of, the one or more secondary networks without adding communication overhead to the API server.

In second embodiments, the target worker node is the first worker node that includes both a checker pod and an agent pod, where receiving the request for the health check of the target CNI comprises the agent pod receiving the request directly from the checker pod.

The preceding second embodiments provides a technical feature of achieving a high efficiency of the agent pod receiving the request, where the high efficiency is due to receiving the request without communication with any network outside of the first worker node.

In third embodiments, the target worker node is the second worker node, where the method comprises configuring, by a cluster node of the multiple nodes, a main network within the containerized cluster, and where receiving the request comprises the agent pod receiving the request from the checker pod via the main network.

The preceding third embodiments provide a technical feature of achieving efficient inter-worker node communication, via use of the main network, between the first worker node comprising the checker pod and the second worker node comprising the agent pod.

In fourth embodiments, the results include one or more positive results of configuring the one or more secondary networks by the target CNI, one or more negative results of configuring the one or more secondary networks 60 by the target CNI, or combinations thereof, and wherein each negative result is due to a functionality failure or a connection failure.

The preceding third embodiments provide a technical feature of identifying each negative result as being a functionality failure or a connection failure, and such failure can be more specifically identifiable via use of a status code, which enables a negative result to be efficiently identified, and subsequently repaired, with specificity and timeliness.

In fourth embodiments, the checker pod in the first worker node is the only checker pod in the multiple worker nodes, where the checker pod in the first worker node is configured to check the health all target CNIs in the multiple worker nodes, where each worker node of the multiple worker nodes includes a host network namespace, where each host network namespace has an associated host consisting of a physical machine or a virtual machine, and where the target CNI does not include interfaces that communicate with the one or more secondary networks but instead uses the host network namespace in the second worker node to communicate with the one or more secondary networks.

The preceding fourth embodiments provide a technical feature of using only one checker pod to check the health all target CNIs, which minimizes use of resources and minimizes connections to the secondary networks. Unlike the checker pod that has its own interfaces, the agent pod does not have its own interfaces but instead uses the interfaces of the host network namespace to communicate with the main network and the one more secondary networks. Thus, there is no need to create a checker pod in each worker node having the target CNI, which would be an overhead for the containerized cluster, since the agent pod, by not having its own individual interface and instead using the interfaces of the host network namespace, enables testing the functionality and connectivity of the target CNI, with only the host network namespace, in a lightweight manner (i.e., in a simpler and more efficient manner).

In fifth embodiments, the containerized cluster is a Kubernetes cluster.

The preceding fifth embodiments provide a technical feature of using a Kubernetes cluster which is widely available and supported as an open-source container orchestration platform that automates the deployment, scaling, and management of containerized applications.

In sixth embodiments, receiving the request to check a health of the target CNI comprises receiving, by an agent container within the agent pod, the request from a checker container within the checker pod.

The preceding sixth embodiments provide a technical feature of using containers with consequent containerization including encapsulating an application and its dependencies into the container, making it easy to deploy and run the application in different environments since programs running inside a container can only use the contents of the container and devices assigned to the container.

In seventh embodiments, creating the checker pod is implemented via: creating, by a deployment controller manager in the control plane, a definition of the checker pod; randomly selecting, by a scheduler in the control plane, the first worker node from the multiple worker nodes; creating, by a kubelet disposed in the first worker node, the checker pod; calling, by the kubelet, a container runtime in the first worker node to create a checker container inside the checker pod; and creating, by the container runtime in the first worker node, the checker container inside the checker pod.

The preceding seventh embodiments provide a technical feature of creating the checker pod in an organized manner that minimizes computation time and resource utilization.

In eighth embodiments, creating the checker pod is implemented via: creating, by a daemonset controller manager in the control plane, a definition of the agent pod; selecting, by a scheduler in the control plane, the second worker node from the multiple worker nodes; creating, by a kubelet disposed in the second worker node, the agent pod; calling, by the kubelet, a container runtime in the second worker node to create an agent container inside the agent pod; and creating, by the container runtime in the second worker node, the agent container inside the agent pod.

The preceding eighth embodiments provide a technical feature of creating the agent pod in an organized manner that minimizes computation time and resource utilization.

A containerized cluster is a group of interconnected computing nodes that work together to manage, deploy, and run containerized applications and is designed to handle workloads more efficiently by leveraging container technology. Containerization includes encapsulating an application and its dependencies into a container, making it easy to deploy and run the application in different environments.

In one embodiment, the containerized cluster is a Kubernetes cluster which includes a set of computing nodes for running containerized applications. Kubernetes is an open-source container orchestration platform that automates the deployment, scaling, and management of containerized applications. Containerized applications are applications run in isolated packages of code called containers. Containers include resources needed by an application to run on a host operating system. Such resources may include, inter alia, libraries, binaries, configuration files, etc.

The following description of embodiments of the present invention are discussed in terms of a Kubernetes cluster but are applicable to a containerized cluster generally.

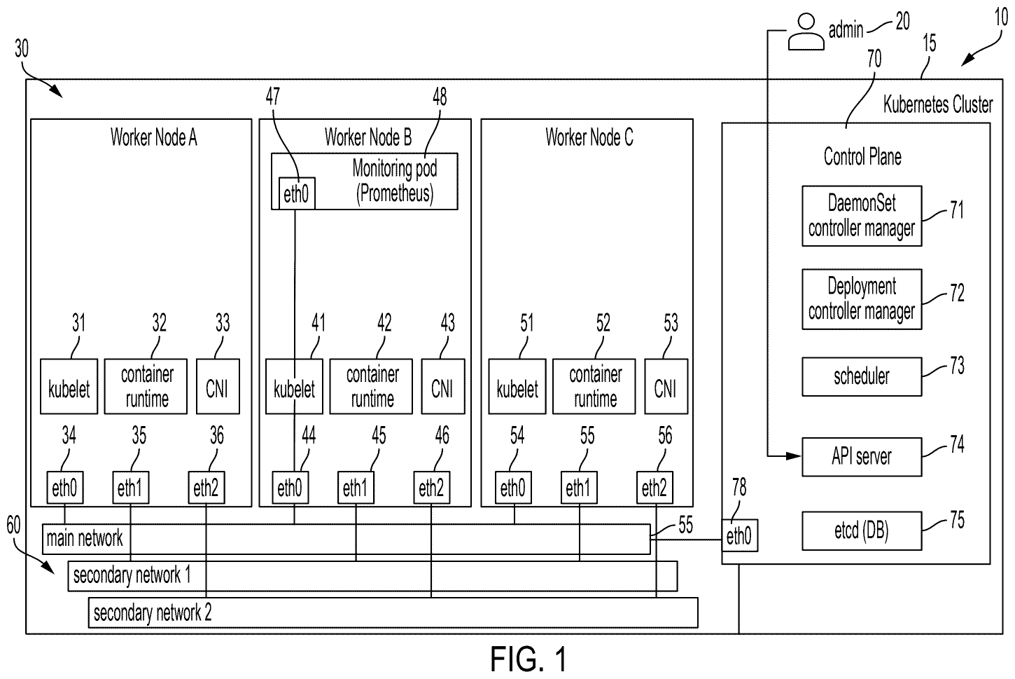

FIG. 1 depicts a system 10 comprising a Kubernetes cluster 15 and an Admin 20 which is a person responsible for managing and maintaining the Kubernetes cluster 15, in accordance with embodiments of the present invention.

The Kubernetes cluster 15 comprises multiple worker nodes 30, a control plane 70 comprising control plane nodes 71-75 and an interface eth0 78, a main network 55, and one or more secondary networks 60. The multiple worker nodes comprise two or more worker nodes, and include worker node A, worker node B, and worker node C in the embodiments of FIG. 1.

Each worker node is a physical machine or a virtual machine that includes one or more pods, wherein each pod is a running process and may include containers configured to run containerized applications.

Each worker node comprises a kubelet, a container runtime, a container network interface (CNI), and eth interfaces.

Worker node A comprises kubelet 31, container runtime 32, CNI 33, and eth interfaces eth0 34, eth1 35 and eth2 36.

Worker node B comprises kubelet 41, container runtime 42, CNI 43, and eth interfaces eth0 44, eth1 45 and eth2 46.

Worker node C comprises kubelet 51, container runtime 52, CNI 53, and eth interfaces eth0 54, eth1 55 and eth2 56.

The eth interfaces are physical or virtual network interfaces used to manage network traffic.

Worker node B also comprises a monitoring pod 48 which monitors results of a health check of CNIs within the worker nodes. There can be a monitoring pod in each worker node of the multiple worker nodes 30. Thus, the number of monitoring pods is less than or equal to the number of worker nodes.

The monitoring pod 48 includes an eth interface eth0 47 which is connected to eth interface eth0 44.

A kubelet creates pods and ensures that containers are running in a pod.

A container runtime is software for running containers and provides tools and functionalities to manage life cycles of containers, including creation, execution, and destruction of containers. The container runtime interfaces with the operating system to provide the resources and isolation required for containers to run efficiently and securely.

A container network interface (CNI) is a plugin that manages the networking of pods and nodes, and is responsible for maintaining connectivity to hosts, inserting a network interface into a container network namespace, and assigning an Internet Protocol (IP) address to the network interface that is inserted into the container network namespace.

Each CNI may be designated (e.g., via input) as a target CNI. A target CNI is a CNI to be health-checked for connection between worker nodes and the secondary networks. One or more CNIs can be target CNIs.

A container network namespace enables containers to operate as if the containers are on separate networks, even though the containers are running on the same host machine. Each container can have its own container network namespace and thus be isolated from other containers and the host system.

Each worker node includes a host network namespace, and each host network namespace has an associated host comprising a physical machine or a virtual machine.

The main network 55 facilitates communication between and among the multiple worker nodes that include worker node A, worker node B, and worker node C.

The secondary networks 60, which generally include one or more secondary networks, include secondary network 1 and secondary network 2 in the embodiments of FIG. 1.

Embodiments of the present invention use the secondary networks to check the health of target CNI's with respect to connections between the worker nodes and the secondary networks via eth interfaces.

The worker node A, the worker node B, and the worker node C are connected to the main network 55 via eth interfaces eth0 34, eth0 44, and eth0 54, respectively.

The main network 55 is connected to the control plane 70 via eth interface eth0 78.

The worker node A, the worker node B, and the worker node C are connected to the secondary network 1 via eth interfaces eth1 35, eth1 45, and eth1 55, respectively.

The worker node A, the worker node B, and the worker node C are connected to the secondary network 2 via eth interfaces eth2 36, eth2 46, and eth2 56, respectively.

The control plane 70, which manages the worker nodes and the pods, include the following control plane nodes: a daemonset controller manager 71, a deployment controller manager 72, a scheduler 73, an Application Programming Interface (API) server 74, and an etcd database (DB) 75.

The control plane 70 also include interface eth0 78. The control plane 70 and the main network 55 are connected to each other via interface eth0 78.

The daemonset controller manager 71 manages the lifecycle of DaemonSets. A DaemonSet is a type of workload object that ensures that a copy of a specific pod runs on all or some nodes in a cluster.

The deployment controller manager 72 manages the lifecycle of deployment objects by providing declarative updates to an application to enable the application to transition from a current state to a desired state.

The scheduler 73 schedules pods onto nodes by selecting a node for a pod to run on based on various criteria.

The API server 74 exposes a Kubernetes API, which allows applications and other control plane components to communicate with one another. The Admin 20 manages and maintains the Kubernetes cluster 15 via the API server 74.

The etcd DB 75 stores data (e.g., configuration data, state data, metadata, etc.). In one embodiment, the etcd DB 75 utilizes Prometheus, which is an open source toolkit, to collect and store the data.

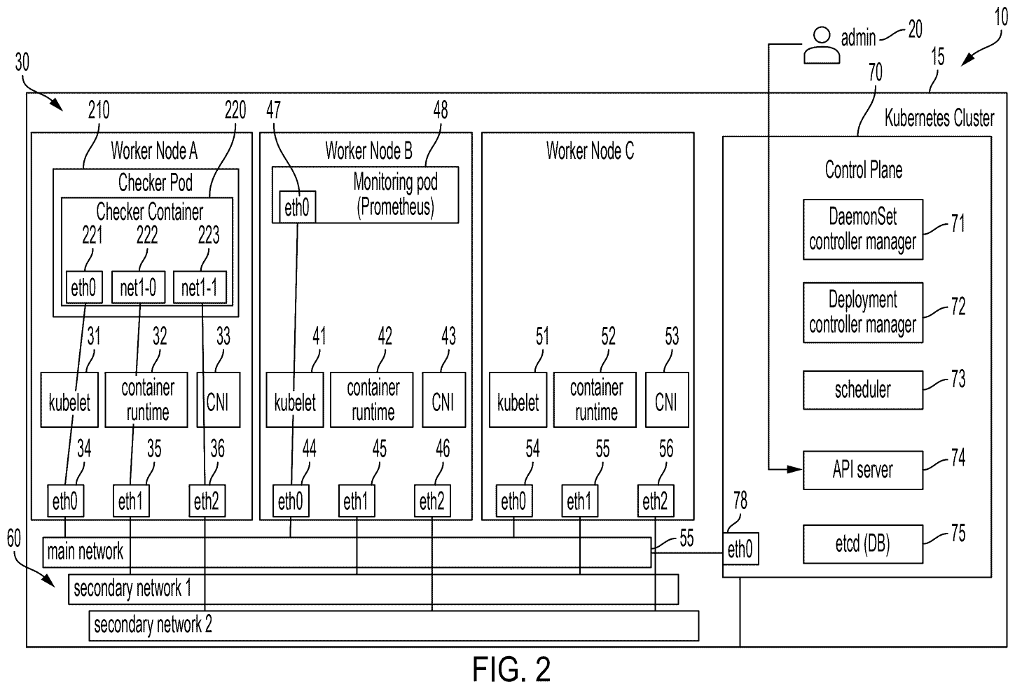

FIG. 2 depicts the system 10 of FIG. 1 with a checker pod 210 inserted into worker node A in the Kubernetes cluster 15, in accordance with embodiments of the present invention.

The checker pod 210 includes a checker container 220 and interfaces eth0 221, net1-0 222 and net1-1 223. The interfaces eth0 221 and eth0 34 are connected to each other. The interfaces net1-0 222 and eth1-35 are connected to each other. The interfaces net1-1 223 and eth2 36 are connected to each other.

The checker pod 210 may be created via the process of: (a) the deployment controller manager 72 creates a definition of the checker pod 210, (b) the scheduler 73 randomly selects worker node A from the multiple worker nodes 30 and assigns the checker pod 210 to worker node A, (c) the kubelet 31, which is disposed in worker node A, creates the checker pod 210 in worker node A; (d) the kubelet 31 calls the container runtime 32 to create checker container 220 (with a file system, a network, storage and image handling) inside the checker pod 210 and to create interfaces eth0 221, net1-0 222 and net1-1 223 inside the checker container 220; and (e) the container runtime 32 creates checker container 220 inside the checker pod 210.

In one embodiment, the scheduler 73 randomly selects worker node A from the multiple worker nodes 30 using a uniform probability density function that weights each worker node equally.

In one embodiment, the scheduler 73 randomly selects worker node A from the multiple worker nodes 30 using a non-uniform probability density function that weights the worker nodes in accordance with predetermined weights for the worker nodes (e.g., via user input).

In one embodiment, there is only one checker pod in the multiple worker nodes, namely checker pod 210, and checker pod 210 is configured to check the health of all of the target CNIs in the worker nodes 30.

One of the worker nodes is designated as including a cluster CNI, which is a CNI that configures the main network 55 by configuring the IP address of the cluster CNI and making the IP address of the cluster CNI available to the other worker nodes.

A target CNI configures the secondary networks, which includes configuring the secondary network 1 and the secondary network 2.

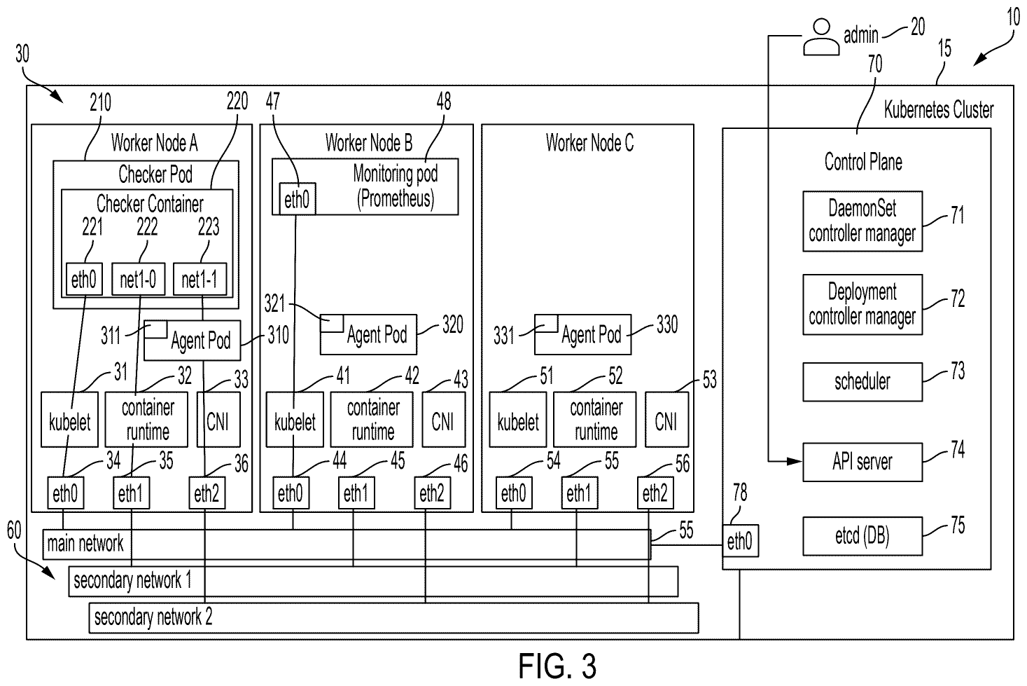

FIG. 3 depicts system 10 of FIG. 2 with agent pod 310, agent pod 320, and agent pod 330 inserted into worker node A, worker node B, and worker node C, respectively, in accordance with embodiments of the present invention.

In one embodiment, an agent pod is inserted into each worker node that includes a target CNI, and an agent container may be included in each agent pod.

Each agent pod in each worker node may performs tasks related to the management and operation of the respective worker node, and more specifically may organize a health check of the target CNI in the worker node that includes the agent pod.

The agent pod 320 may be created via the process of: (a) the daemonset controller manager 71 creates a definition of the agent pod 320, (b) the scheduler 73 assigns the agent pod 320 to worker node B, (c) the kubelet 41, which is disposed in worker node B, creates the agent pod 320 in worker node B; (d) the kubelet 41 calls the container runtime 42 to create an agent container 321 (with a file system, a network, storage and image handling) inside the agent pod 320 and (e) the container runtime 42 creates agent container 321 inside the agent pod 320.

The agent pod 330 may be created via the process of: (a) the daemonset controller manager 71 creates a definition of the agent pod 330, (b) the scheduler 73 assigns the agent pod 330 to worker node C, (c) the kubelet 51, which is disposed in worker node C, creates the agent pod 330 in worker node C; (d) the kubelet 51 calls the container runtime 52 to create an agent container 331 (with a file system, a network, storage and image handling) inside the agent pod 330.

The agent pod 310 may be created via the process of: (a) the daemonset controller manager 71 creates a definition of the agent pod 310, (b) the scheduler 73 assigns the agent pod 310 to worker node A, (c) the kubelet 31, which is disposed in worker node A, creates the agent pod 310 in worker node A; (d) the kubelet 31 calls the container runtime 32 to create an agent container 311 (with a file system, a network, storage and image handling) inside the agent pod 330.

Unlike the checker pod 210 that has its own interfaces (eth0 221, net1-0 222, net1-1 223), the agent pod does not have its own interfaces but instead uses the interfaces (eth0 44, eth1 45, eth2 46) of the host network namespace in worker node B to communicate with the main network 55, the secondary network 1, the secondary network 2. Thus, there is no need to create a checker pod in each worker node having the target CNI, which would be an overhead for the cluster, since the agent pod, by not having its own individual interface and instead using the interfaces of the host network namespace, enables testing the functionality and connectivity of the target CNI, with only the host network namespace, in a lightweight manner (i.e., in a simpler and more efficient manner).

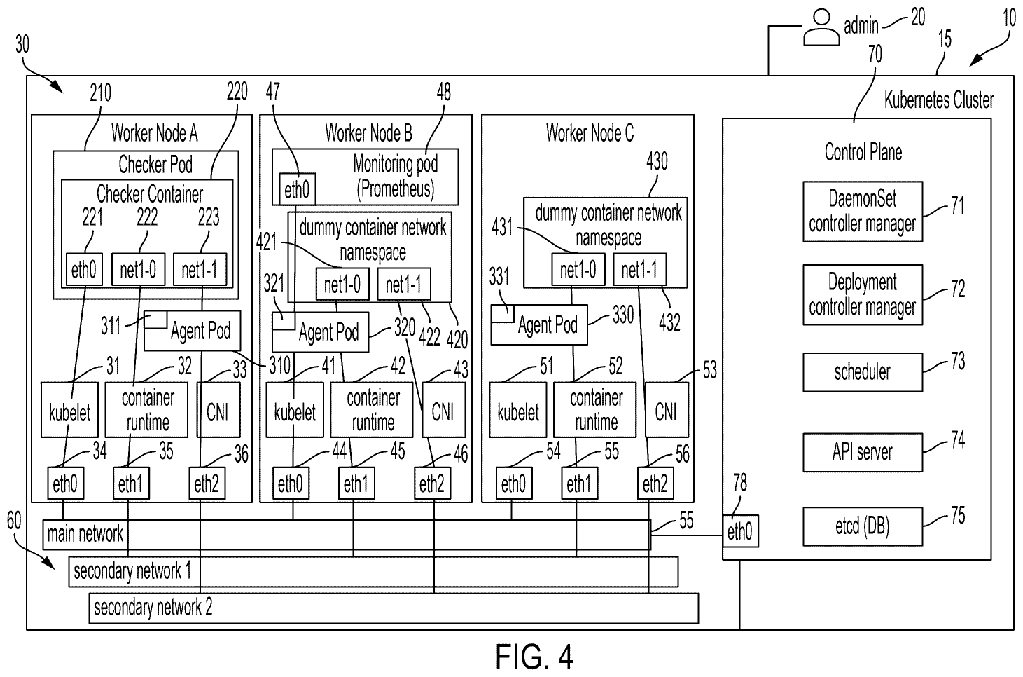

FIG. 4 depicts system 10 of FIG. 3 with health checking of target CNIs utilizing dummy container network namespaces, in accordance with embodiments of the present invention.

In one embodiment, each dummy container network namespace may be a Linux network namespace.

The dummy container network namespace 420 includes interfaces net1-0 421 and net1-1 422. The interfaces net1-0 421 and eth1 45 are connected to each other. The interfaces net1-1 422 and eth2 46 are connected to each other.

The dummy container network namespace 430 includes interfaces net1-0 431 and net1-1 432. The interfaces net1-0 431 and eth1 55 are connected to each other. The interfaces net1-1 432 and eth2 56 are connected to each other.

Although not shown, worker node A likewise includes a dummy container network namespace.

The CNI 33, the CNI 43, and the CNI 53 are each a target CNI whose health is to be checked by the following method illustrated for target node 43 and agent pod 320 in worker node B.

The checker container 220 within the checker pod 210 in worker node A sends, via the main network 55, a request: (i) to the agent container 321 within the agent pod 320 in worker node B to check the health of the target CNI 43 in worker node B and (ii) to the agent container 331 within the agent pod 330 in worker node C to check the health of the target CNI 53 in worker node C via the main network 55, as shown by the arrows. However, the checker pod 210 in worker node A can send a request directly to the agent container 311 within the agent pod 310 in worker node A to check the health of the target CNI 33 in worker node A.

The agent pod 310 in worker node A, the agent pod 320 in worker node B and the agent pod 330 in worker node C each receive the respective request sent by the checker pod 210.

The following steps are for target CNI 43 and agent pod 320 in worker node B.

In response to receiving the respective request, the agent pod 320 creates the dummy container network namespace 420 in the target worker node B.

The target CNI 43 executes an ADD command, resulting in the target CNI 43 configuring the one or more secondary networks 60 (which includes secondary network 1 and secondary network 2) within the Kubernetes cluster 15.

The agent pod 320 calls, via the dummy container network namespace 420, endpoints at interfaces etho 221, net1-0 222, and net1-1 223 within checker container 220 of the checker pod 210. The calling of the endpoints triggers a check of connections between the dummy container network namespace 420 and the checker pod 210.

The target CNI 43 executes a DEL command, resulting in reversal the previous configuring of the one or more secondary networks by the target CNI 43.

The agent pod 320 deletes the dummy container network namespace 420 in the target worker node B.

In response to receiving the respective request, the agent pod 330 creates the dummy container network namespace 430 in the target worker node C.

The target CNI 53 executes an ADD command, resulting in the target CNI 53 configuring the one or more secondary networks 60 (which includes secondary network 1 and secondary network 2) within the Kubernetes cluster 15.

The agent pod 330 calls, via the dummy container network namespace 430, endpoints at interfaces etho 221, net1-0 222, and net1-1 223 within checker container 220 of the checker pod 210. The calling of the endpoints triggers a check of connections between the dummy container network namespace 430 and the checker pod 210.

The target CNI 53 executes a DEL command, resulting in reversal the previous configuring of the one or more secondary networks by the target CNI 53.

The agent pod 330 deletes the dummy container network namespace 430 in the target worker node C.

In response to receiving the respective request, the agent pod 310 creates the dummy container network namespace (not shown) in the target worker node A.

The target CNI 33 executes an ADD command, resulting in the target CNI 33 configuring the one or more secondary networks 60 (which includes secondary network 1 and secondary network 2) within the Kubernetes cluster 15.

The agent pod 310 calls, via the dummy container network namespace (not shown) in the target worker node A, endpoints at interfaces etho 221, net1-0 222, and net1-1 223 within checker container 220 of the checker pod 210. The calling of the endpoints triggers a check of connections between the dummy container network namespace (not shown) and the checker pod 210.

The target CNI 33 executes a DEL command, resulting in reversal the previous configuring of the one or more secondary networks by the target CNI 33.

The agent pod 310 deletes the dummy container network namespace (not shown) in the target worker node A.

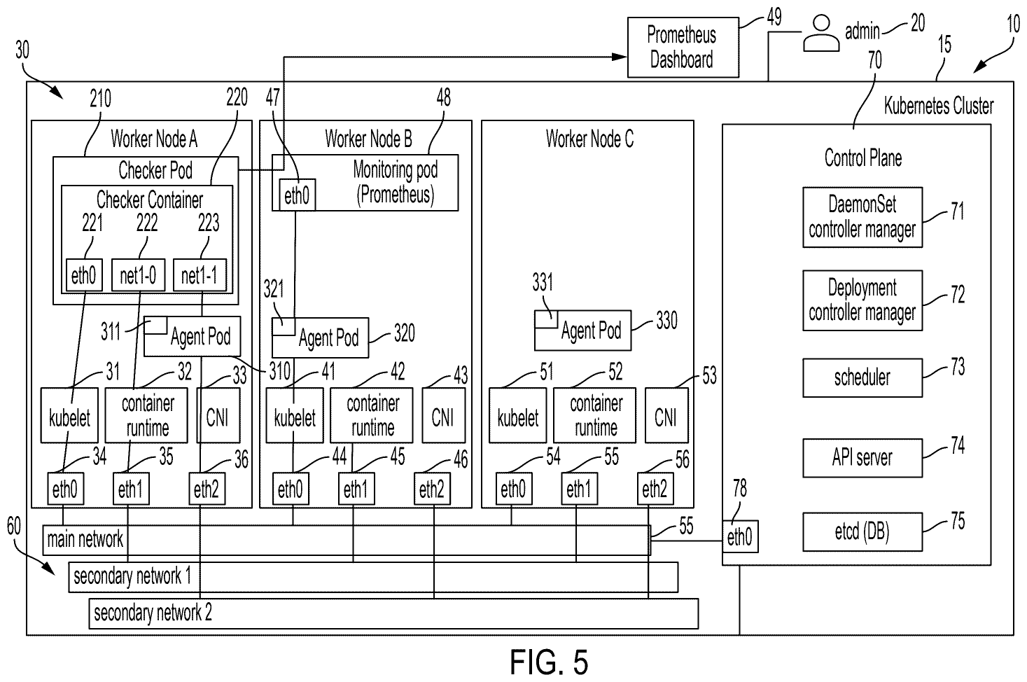

FIG. 5 depicts reporting the results of the health check of target CNI 43 in worker node B, CNI 53 in worker node C, and CNI 33 in worker node A, in accordance with embodiments of the present invention.

The agent pod 320 in worker node B sends, to the checker pod 210 in worker node A via the main network 55, results of the health check of target CNI 43 including: one or more positive results of configuring the one or more secondary networks by the target CNI 43, one or more negative results of configuring the one or more secondary networks by the target CNI 43, or combinations thereof.

In one embodiment, a positive result is a successful result in which the one or more secondary networks are correctly configured by the target CNI 43.

In one embodiment, a negative result is an unsuccessful result in which the one or more secondary networks are not correctly configured, or not configured at all, by the target CNI 43.

A negative result can be due to a functionality failure or a connection failure.

The checker pod 210 in worker node A exports the results to the monitoring pod 48 in worker node B.

The monitoring pod 48 in worker node B makes the results available to the Admin 20 at a Prometheus dashboard 49.

Similarly, the preceding steps may be adapted as follows to report the results of the health check of target CNI 53 in worker node C.

The agent pod 330 in worker node C sends, to the checker pod 210 in worker node A via the main network 55, results of the health check of target CNI 53 including: one or more positive results of configuring the one or more secondary networks by the target CNI 53, one or more negative results of configuring the one or more secondary networks by the target CNI 53, and combinations thereof.

The checker pod 210 in worker node A exports the results to the monitoring pod 48 in worker node B.

The monitoring pod 48 in worker node B makes the results available to the Admin 20 at a Prometheus dashboard 49.

Similarly, the preceding steps may be adapted as follows to report the results of the health check of target CNI 33 in worker node A.

The agent pod 310 in worker node A sends, to the checker pod 210 in worker node A via the main network 55, results of the health check of target CNI 33 including: one or more positive results of configuring the one or more secondary networks by the target CNI 33, one or more negative results of configuring the one or more secondary networks by the target CNI 33, or combinations thereof.

The checker pod 210 in worker node A exports the results to the monitoring pod 48 in worker node B.

The monitoring pod 48 in worker node B makes the results available to the Admin 20 at a Prometheus dashboard 49.

Table 1 depicts a first example of reported positive and negative result of a health check of a target CNI, and Table 2 depicts a second example of reported positive and negative results of a health check of a target CNI.

TABLE 1
First Example of Positive and Negative Results of Health Check

| | Result is Positive | Failure type | Status |
|---|---|---|---|
| Specific Result | or Negative? | if negative | Code |
| OK | positive | | 200 |
| Network Not Found | negative | functionality | 400 |
| Plugin Not Found | negative | functionality | 401 |
| Config Failure | negative | functionality | 500 |
| Plugin Not Support | negative | functionality | 501 |
| Net NS Failed | negative | functionality | 600 |
| IPAM Failure | negative | functionality | 601 |
| Plugin Exec Failure | negative | functionality | 602 |
| Partial Failure | negative | functionality | 603 |
| Daemon Connection Failure | negative | connection | 700 |
| Unknown | negative | functionality | 999 |

TABLE 2
Second Example of Positive and Negative Results of Health

| | Result is Positive | Failure Type | Status |
|---|---|---|---|
| Specific Result | or Negative? | if Negative | Code |
| Success | positive | | 200 |
| Unknown | negative | functionality | 999 |
| Not Found | negative | functionality | 4xx |
| Config Failure | negative | functionality | 5xx |
| CNI Failure | negative | functionality | 6xx |
| Connection Failure | negative | connection | 7xx |

Table 1 and Table 2 each identify a failure type for a negative result. The failure type is a functionality failure type or a connection failure type.

Table 1 and Table 2 includes a Status Code that identifies the health and a cause, which may be a root cause, of failure for both functionality and connectivity types of negative results.

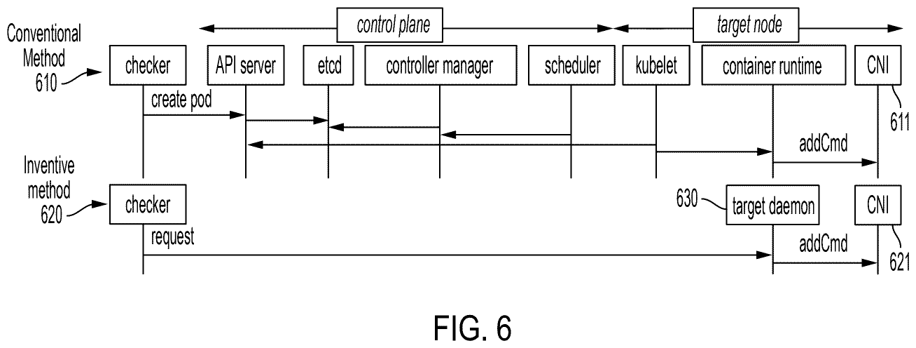

FIG. 6 depicts a comparison of a conventional method 610 and the inventive method 620 of the present invention for checking the health of a target CNI 611 and a target CNI 621, respectively, in accordance with embodiments of the present invention.

Conventionally, the container runtime sends a configuration file to the target CNI 611 which is a lengthy process with numerous steps in the conventional method 610. In contrast, the inventive method 620 has a simpler and more efficient method in which the request to check the health of the CNI 621 is sent by the checker pod directly to the agent pod that is defined by a target daemon 630 within the DaemonSet controller manager 71. The target daemon 630 sends a configuration file directly to the target CNI 621. The configuration file defines parameters to be configured in the secondary networks (e.g., IP addresses of the secondary networks and IP addresses needed for performing the health check on the target CNI).

Thus, there is no need to create a checker pod in each worker node having the target CNI, which would be an overhead for the cluster, since the agent pod, by not having its own individual interface and instead using the interfaces of the host network namespace, enables the target CNI to communicate with the one or more secondary networks in a lightweight manner (i.e., in a simpler and more efficient manner) and to test the functionality and connectivity of the target CNI, with only the host network namespace, likewise in a lightweight manner (i.e., in a simpler and more efficient manner).

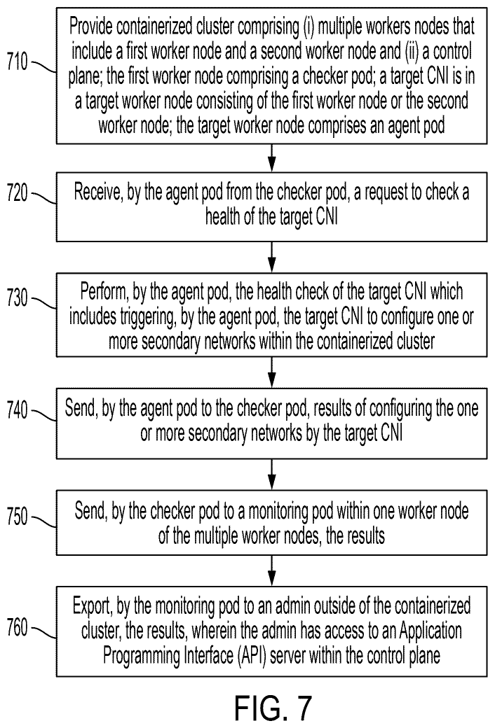

FIG. 7 is a flow chart of a method for assessing a health of a target container network interface (CNI) disposed in a containerized cluster, in accordance with embodiments of the present invention. The flow chart of FIG. 7 includes steps 710-760.

Step 710 provides the containerized cluster (e.g., the Kubernetes cluster 15). The containerized cluster comprises (i) multiple workers nodes 30 that include a first worker node (i.e., worker node A) and a second worker node (i.e., worker node B) and (ii) the control plane 70 configured to manage the worker nodes and pods disposed within the multiple worker nodes. The first and second worker nodes are different worker nodes. The first worker node comprises a checker pod 210. The target CNI is in a target worker node that consists of the first worker node (worker node A) or the second worker node (worker node B). Thus, the target CNI is CNI 33 or CNI 43 if the target worker node is worker node A or worker node B, respectively. The target worker node comprises agent pod 310 or agent pod 320 if the target worker node is worker node A or worker node B, respectively.

In one embodiment, the checker pod 210 is the only checker pod in the multiple worker nodes 30, wherein the checker pod in the first worker node (worker node A) is configured to check the health all target CNIs in the multiple worker nodes 30.

Step 720 receives, by the agent pod from the checker pod 210, a request to check a health of the target CNI. In one embodiment, the request is received periodically (e.g., once per day, once per week, once per month, etc.)

In one embodiment, the target worker node is the first worker node (worker node A) and the agent pod 310 receives the request directly from the checker pod 210.

In one embodiment, the target worker node is the second worker node (worker node B), wherein and the agent pod 320 receives the request, wherein a cluster node of the multiple nodes configures the main network 55, and the agent pod 320 receives the request from the checker pod 210 via the main network 55.

In one embodiment, an agent container within the agent pod receives the request from the checker container 220 within the checker pod 210.

In one embodiment, each worker node includes a host network namespace, and each host network namespace has an associated host comprising a physical machine or a virtual machine. In one embodiment, the target CNI does not include interfaces that communicate with the one or more secondary networks 60 but instead uses the host network namespace in the worker node comprising the target CNI to communicate with the one or more secondary networks.

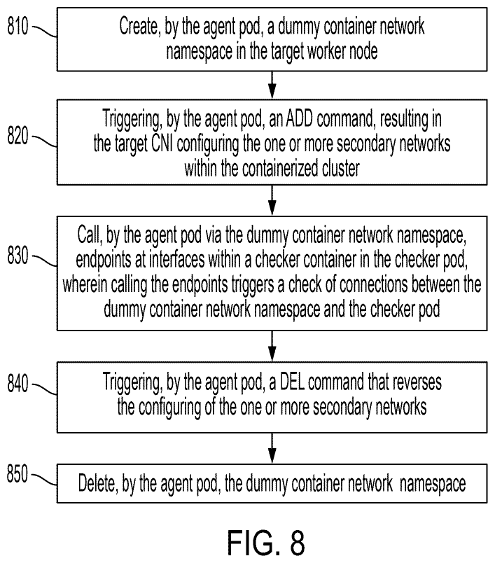

In response to receiving the request, step 730 performs, by the agent pod and the target CNI, the health check of the target CNI which includes configuring, by the target CNI, one or more secondary networks 60 within the containerized cluster. Step 730 is described infra in more detail in FIG. 8.

Step 740 sends, by the agent pod to the checker pod 210, results of configuring the one or more secondary networks 60 by the target CNI. The checker pod 210 receives the results from the agent pod. The results include: one or more positive results of configuring the one or more secondary networks 60 by the target CNI, one or more negative results of configuring the one or more secondary networks 60 by the target CNI, or combinations thereof.

In one embodiment, a positive result is a successful result in which the one or more secondary networks are correctly configured by the target CNI.

In one embodiment, a negative result is an unsuccessful result in which the one or more secondary networks are not correctly configured, or not configured at all, by the target CNI.

In one embodiment, negative result is due to a functionality failure or a connection failure.

Step 750 sends, by the checker pod 210 to a monitoring pod 48 within one worker node of the multiple worker nodes, the results. In one embodiment, the one worker node comprising the monitoring pod 48 is the worker node B.

Step 760 exports, by the monitoring pod 48 to the admin 20 outside of the containerized cluster (e.g., the Kubernetes cluster 15), the results, wherein the admin 20 has access to the API server 74 within the control plane 70.

FIG. 8 is a flow chart of a process that performs the health check of the target CNI in step 730 of FIG. 7 in more detail, in accordance with embodiments of the present invention. The flow chart of FIG. 8 includes steps 810-850.

Step 810 creates, by the agent pod, a dummy container network namespace in the target worker node (e.g., the dummy container network namespace if the target worker node is worker node B).

Step 820 triggers, by the agent pod, an ADD command, resulting in the target CNI configuring the one or more secondary networks 60 within the containerized cluster 15.

Step 830 calls, by the agent pod via the dummy container network namespace, endpoints at interfaces (eth0 221, net1-0 222, net1-1 223) within the checker container 220 of the checker pod 210, wherein calling the endpoints triggers a check of connections between the dummy container network namespace 420 and the checker pod 210.

Step 840 triggers, by the agent pod, a DEL command that reverses the configuring of the one or more secondary networks 60 in step 820.

Step 850 deletes, by the agent pod, the dummy container network namespace.

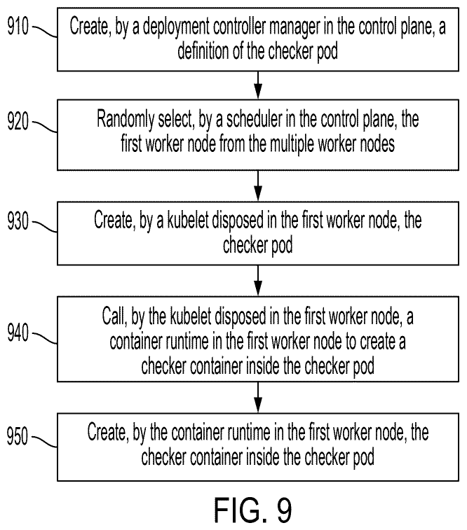

FIG. 9 is a flow chart of a process that creates the checker pod 210, in accordance with embodiments of the present invention. The flow chart of FIG. 9 includes steps 910-950.

Step 910 creates, by the deployment controller manager 72 in the control plane 70, a definition of the checker pod 210.

Step 920 randomly selects, by the scheduler 73 in the control plane 70, the first worker node (worker node A) from the multiple worker nodes.

Step 930 creates, by a kubelet 31 disposed in the first worker node, the checker pod 210.

Step 940 calls, by the kubelet 31, the container runtime 32 in the first worker node to create a checker container inside the checker pod 210.

Step 950 creates, by the container runtime 32 in the first worker node, the checker container 220 inside the checker pod 210.

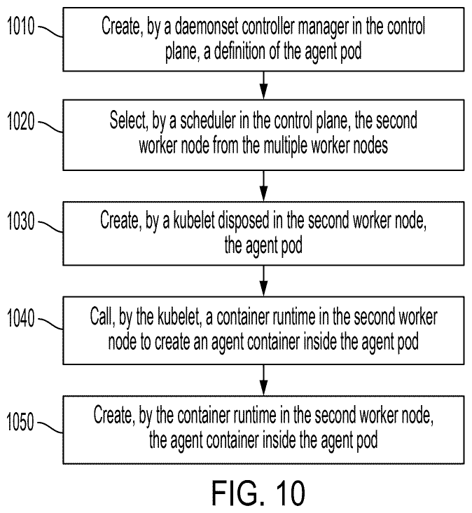

FIG. 10 is a flow chart of a process that creates the agent pod 320 in worker node B, in accordance with embodiments of the present invention. The flow chart of FIG. 10 includes steps 1010-1050.

Step 1010 creates, by the daemonset controller manager 71 in the control plane 70, a definition of the agent pod 43.

Step 1020 selects, by the scheduler 73 in the control plane 70, the second worker node (worker node B) from the multiple worker nodes.

Step 1030 creates, by a kubelet 41 disposed in the second worker node, the agent pod 43.

Step 1040 calls, by the kubelet 41, a container runtime 42 in the second worker node to create an agent container inside the agent pod 320.

Step 1050 creates, by the container runtime 42 in the second worker node, the agent container 321 inside the agent pod 320.

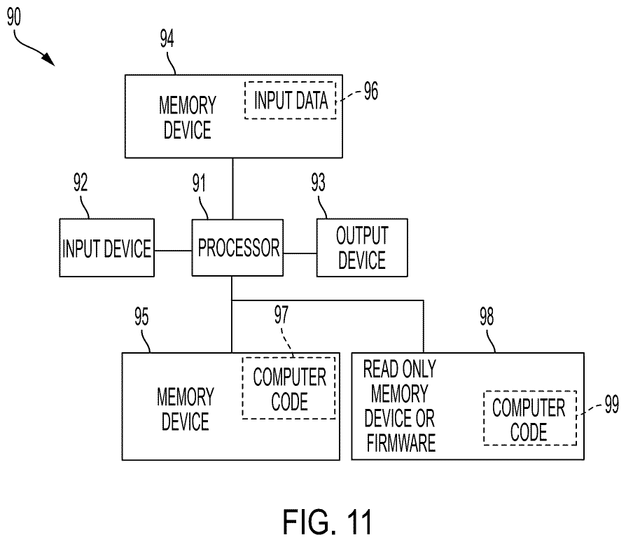

FIG. 11 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 11 shows the computer system 90 as a particular configuration of hardware and software, any configuration of hardware and software, as would be known to a person of ordinary skill in the art, may be utilized for the purposes stated supra in conjunction with the particular computer system 90 of FIG. 11. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

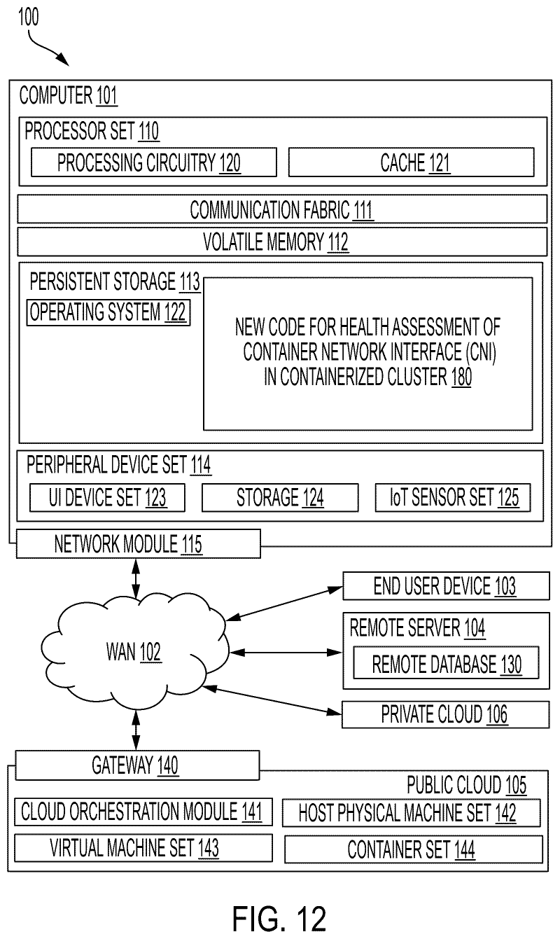

FIG. 12 depicts a computing environment 100 which contains an example of an environment for the execution of at least some of the computer code involved in performing the inventive methods, in accordance with embodiments of the present invention. Such computer code includes new code for health assessment of container network interface (CNI) in containerized cluster 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for assessing a health of a target container network interface (CNI) disposed in a containerized cluster, said method comprising:
providing, by one or more processors of a computer system, the containerized cluster, said containerized cluster comprising (i) multiple workers nodes that include a first worker node and a second worker node and (ii) a control plane configured to manage the worker nodes and pods disposed within the multiple worker nodes, said first worker node comprising a checker pod, said target CNI being in a target worker node comprising the first worker node or the second worker node, said target worker node comprising an agent pod;
receiving, by the agent pod from the checker pod using the one or more processors, a request to check a health of the target CNI;
in response to said receiving the request, performing by the agent pod, using the one or more processors, the health check of the target CNI, said performing the health check of the target CNI comprising triggering, by the agent pod, the target CNI to configure one or more secondary networks within the containerized cluster; and
sending, by the agent pod to the checker pod using the one or more processors, results of configuring the one or more secondary networks by the target CNI.

2. The method of claim 1, wherein said performing the health check of the target CNI comprises:
creating, by the agent pod, a dummy contained network namespace in the target worker node;
triggering, by the agent pod, the target CNI to execute an ADD command, resulting in the target CNI configuring the one or more secondary networks within the containerized cluster;
triggering, by the agent pod, the target CNI to execute a DEL command that reverses the configuring of the one or more secondary networks; and
deleting, by the agent pod, the dummy container network namespace.

3. The method of claim 2, said method comprising:
calling, by the agent pod via the dummy container network namespace using the one or more processors, endpoints at interfaces within the checker pod, wherein said calling the endpoints triggers a check of connections between the dummy container network namespace and the checker pod.

4. The method of claim 1, wherein the target worker node is the first worker node, and wherein said receiving the request comprises the agent pod receiving the request directly from the checker pod.

5. The method of claim 1, wherein the target worker node is the second worker node, wherein the method comprises configuring, by a cluster node of the multiple nodes, a main network within the containerized cluster, and wherein said receiving the request comprises the agent pod receiving the request from the checker pod via the main network.

6. The method of claim 1, said method comprising:
sending, by the checker pod to a monitoring pod within one worker node of the multiple worker nodes using the one or more processors, the results; and
exporting, by the monitoring pod to an admin outside of the containerized cluster using the one or more processors, the results, wherein the admin has access to an API server node within the control plane.

7. The method of claim 1, wherein the results include one or more positive results of configuring the one or more secondary networks by the target CNI, one or more negative results of configuring the one or more secondary networks 60 by the target CNI, or combinations thereof, and wherein each negative result is due to a functionality failure or a connection failure.

8. The method of claim 1, wherein the checker pod in the first worker node is the only checker pod in the multiple worker nodes, and wherein the checker pod in the first worker node is configured to check the health all target CNIs in the multiple worker nodes.

9. The method of claim 1, wherein the containerized cluster is a Kubernetes cluster.

10. The method of claim 1, wherein said receiving the request to check a health of the target CNI comprises receiving, by an agent container within the agent pod, the request from a checker container within the checker pod.

11. The method of claim 1, wherein each worker node of the multiple worker nodes includes a host network namespace, and wherein each host network namespace has an associated host comprising a physical machine or a virtual machine.

12. The method of claim 11, wherein the target CNI does not include interfaces that communicate with the one or more secondary networks but instead uses the host network namespace in the second worker node to communicate with the one or more secondary networks.

13. The method of claim 1, said method comprising: creating, using the one or more processors, the checker pod via:
creating, by a deployment controller manager in the control plane, a definition of the checker pod;
randomly selecting, by a scheduler in the control plane, the first worker node from the multiple worker nodes;
creating, by a kubelet disposed in the first worker node, the checker pod;
calling, by the kubelet, a container runtime in the first worker node to create a checker container inside the checker pod; and
creating, by the container runtime in the first worker node, the checker container inside the checker pod.

14. The method of claim 1, said method comprising: creating, using the one or more processors, the agent pod via:
creating, by a daemonset controller manager in the control plane, a definition of the agent pod;
selecting, by a scheduler in the control plane, the second worker node from the multiple worker nodes;
creating, by a kubelet disposed in the second worker node, the agent pod;
calling, by the kubelet, a container runtime in the second worker node to create an agent container inside the agent pod; and
creating, by the container runtime in the second worker node, the agent container inside the agent pod.

15. A computer program product, comprising one or more computer readable hardware storage devices having computer readable program code stored therein, said program code containing instructions executable by one or more processors of a computer system to implement a method for assessing a health of a target container network interface (CNI) disposed in a containerized cluster, said method comprising:
providing, by the one or more processors, the containerized cluster, said containerized cluster comprising (i) multiple workers nodes that include a first worker node and a second worker node and (ii) a control plane configured to manage the worker nodes and pods disposed within the multiple worker nodes, said first worker node comprising a checker pod, said target CNI being in a target worker node comprising the first worker node or the second worker node, said target worker node comprising an agent pod;
receiving, by the agent pod from the checker pod using the one or more processors, a request to check a health of the target CNI;
in response to said receiving the request, performing by the agent pod, using the one or more processors, the health check of the target CNI, said performing the health check of the target CNI comprising configuring, by the target CNI, one or more secondary networks within the containerized cluster; and
sending, by the agent pod to the checker pod using the one or more processors, results of configuring the one or more secondary networks by the target CNI.

16. The method of claim 15, wherein said performing the health check of the target CNI comprises:
creating, by the agent pod, a dummy contained network namespace in the target worker node;
triggering, by the agent pod, the target CNI to execute an ADD command, resulting in the target CNI configuring the one or more secondary networks within the containerized cluster;
triggering, by the agent pod, the target CNI to execute a DEL command that reverses the configuring of the one or more secondary networks; and
deleting, by the agent pod, the dummy container network namespace.

17. The method of claim 16, said method comprising:
calling, by the agent pod via the dummy container network namespace using the one or more processors, endpoints at interfaces within the checker pod, wherein said calling the endpoints triggers a check of connections between the dummy container network namespace and the checker pod.

18. A computer system, comprising one or more processors, one or more memories, and one or more computer readable hardware storage devices, said one or more hardware storage devices containing program code executable by the one or more processors via the one or more memories to implement a method for assessing a health of a target container network interface (CNI) disposed in a containerized cluster, said method comprising:
providing, by the one or more processors, the containerized cluster, said containerized cluster comprising (i) multiple workers nodes that include a first worker node and a second worker node and (ii) a control plane configured to manage the worker nodes and pods disposed within the multiple worker nodes, said first worker node comprising a checker pod, said target CNI being in a target worker node comprising the first worker node or the second worker node, said target worker node comprising an agent pod;
receiving, by the agent pod from the checker pod using the one or more processors, a request to check a health of the target CNI;
in response to said receiving the request, performing by the agent pod and the target CNI, using the one or more processors, the health check of the target CNI, said performing the health check of the target CNI comprising configuring, by the target CNI, one or more secondary networks within the containerized cluster; and
sending, by the agent pod to the checker pod using the one or more processors, results of configuring the one or more secondary networks by the target CNI.

19. The method of claim 18, wherein said performing the health check of the target CNI comprises:
creating, by the agent pod, a dummy contained network namespace in the target worker node;
triggering, by the agent pod, the target CNI to execute an ADD command, resulting in the target CNI configuring the one or more secondary networks within the containerized cluster;
triggering, by the agent pod, the target CNI to execute a DEL command that reverses the configuring of the one or more secondary networks; and
deleting, by the agent pod, the dummy container network namespace.

20. The method of claim 19, said method comprising:
calling, by the agent pod via the dummy container network namespace using the one or more processors, endpoints at interfaces within the checker pod, wherein said calling the endpoints triggers a check of connections between the dummy container network namespace and the checker pod.
